(19) United States
(12) Patent Application Publication
(10) Pub. No.: US 2020/0277164 A1
(43) Pub. Date: Sep. 3, 2020

(54) WORKING PLATFORM FOR AN ELEVATOR CAR

(71) Applicant: Otis Elevator Company, Farmington, CT (US)

(72) Inventor: Aurelien Fauconnet, Isdes (FR)

(21) Appl. No.: 16/725,513

(22) Filed: Dec. 23, 2019

(30) Foreign Application Priority Data
Mar. 1, 2019 (EP) 19160333.1

(51) Int. Cl. B66B 11/02; B66B 19/00

(52) U.S. Cl. CPC B66B 11/0246; B66B 19/00; B66B 11/0226

(57) ABSTRACT

The invention relates to a working platform for an elevator car comprising a passenger space for accommodating passengers and at least one handrail within the passenger space. The working platform comprises a plurality of platform elements configured for being supported in a working position within the elevator car by the at least one handrail of the elevator car for providing the working platform.

### FOREIGN PRIORITY

This application claims priority to European Patent Application No. 19160333.1, filed Mar. 1, 2019, and all the benefits accruing therefrom under 35 U.S.C. § 119, the contents of which in its entirety are herein incorporated by reference.

### BACKGROUND

The invention relates to a working platform for an elevator car. The invention further relates to an elevator car and to an elevator system comprising a working platform, and to a method of installing a working platform within an elevator car.

An elevator system typically comprises an elevator car moving along a hoistway extending between a plurality of landings, and an elevator drive configured for driving the elevator car.

For repair and/or maintenance, there may be a need for a mechanic to access components located at the top of the elevator car or components arranged within the hoistway above the elevator car.

It therefore is desirable to provide a structure which allows a mechanic to access components located at the top of the elevator car or components arranged within the hoistway above the elevator car more easily.

### SUMMARY

According to an exemplary embodiment of the invention, a working platform is provided for an elevator car, the elevator car comprising a passenger space for accommodating passengers, and at least one handrail within the passenger space. The working platform includes a plurality of individual platform elements. The platform elements are configured for being supported in a working position within the elevator car, in which they are supported by the at least one handrail of the elevator car. When arranged in said working position, the platform elements, in combination, provide the working platform. A mechanic may climb onto the working platform for safely accessing components of the elevator system arranged at the top the elevator car and/or within the hoistway.

Exemplary embodiments of the invention include an elevator car comprising at least one handrail; and a working platform according to an exemplary embodiment of the invention.

Exemplary embodiments of the invention further include an elevator system comprising a hoistway extending between a plurality of landings; and at least one elevator car according to an exemplary embodiment of the invention, which is configured for moving along the hoistway between the plurality of landings.

Exemplary embodiments of the invention further include a method of installing a working platform in an elevator car according to an exemplary embodiment of the invention, wherein the method comprises taking at least two platform elements from respective storage positions and supporting the at least two platform elements on the at least one handrail of the elevator car.

As, according to exemplary embodiments of the invention, the platform elements are supported on handrails provided within the elevator car, there is no need for providing additional supporting elements within the elevator car. In consequence, a working platform according to an exemplary embodiment of the invention may be provided and installed at low costs, and no space within the elevator car is occupied by additional supporting elements for supporting the platform elements.

Since the working platform is formed by a plurality of platform elements, each of the platform elements is smaller than the working platform. The reduced size of the platform elements facilitates the handling and storage of the platform elements. A working platform according to an exemplary embodiment of the invention in particular may be installed and deinstalled by a single mechanic on its own, as each platform element may be configured to be small and light enough for being handled by a single mechanic

In consequence, a working platform according to exemplary embodiments of the invention provides a structure which may be installed and deinstalled easily within an elevator car and which allows a mechanic to position himself safely in an elevated position above the bottom of the elevator car. This allows the mechanic to access components located at the top of the elevator car or components arranged on top of the elevator car and/or within the hoistway safely and conveniently by reaching through an opening formed within an upper portion of the elevator car.

A number of optional features are set out in the following. These features may be realized in particular embodiments, alone or in combination with any of the other features, unless specified otherwise.

The platform elements may be configured to be arranged next to each other in their respective working positions, from where maintenance and repair of components located on top of the elevator car and/or within the hoistway are feasible, for forming a continuous working platform, in particular a continuous working platform which does not comprise any gaps between adjacent platform elements. This enhances the safety of the working platform as the mechanic may not fall into or stumble over gaps formed between adjacent platform elements.

The platform elements may be configured to establish, in combination, a working platform extending basically over the whole horizontal cross section of the passenger space, when the platform elements are arranged in their respective working positions. This provides a very safe working platform as a working platform extending basically over the whole horizontal cross section of the passenger space, i.e. over the whole distance between opposite sidewalls of the elevator car, prevents a mechanic from falling laterally from the working platform.

Each platform element may comprise a plate which is configured to extend horizontally within the elevator car, when the platform element is arranged in its working position, and at least one leg configured for supporting the platform element on the at least one handrail. The at least one leg may be movable, in particular pivotable, between a retracted storage position and an extended working position. The at least one leg may be configured for supporting the platform element on the at least one handrail when arranged in the extended working position.

A method of installing a working platform according to an exemplary embodiment of the invention may include moving at least one leg of at least one of the platform elements from a retracted storage position into an extended working position and supporting the at least one leg on the at least one handrail of the elevator car for supporting the at least one platform element on the at least one handrail of the elevator car.

When arranged in the retracted storage position the at least one leg may extend basically parallel to the plate for reducing the space occupied by the platform element, in order to facilitate the storage of the platform element.

In order to allow securely supporting the at least one leg on one of the handrails, the at least one leg may comprise at least one cut-out, which is formed within a first end of the at least one leg and configured for accommodating at least a portion of the at least one handrail when the working platform is supported on said at least one handrail.

The at least one leg may further comprise a supporting surface formed at a second end of the leg opposite to the cut-out. The supporting surface may be configured for abutting against the plate of the working platform element when the leg is arranged in its working position, supporting the plate on the leg and preventing the leg from pivoting beyond its working position.

For providing a symmetric configuration resulting in a symmetric distribution of the acting forces, each platform element may comprise two legs mounted to opposite ends of the platform element, wherein each leg is configured for being supported on one of two handrails provided at opposite sidewalls of the elevator car.

In order to allow fixing the platform elements in respective storage positions, each platform element may comprise at least one fixing opening configured for accommodating a corresponding fixing element.

In order to allow for a convenient storage of the platform elements, in particular in a space-saving configuration, an elevator car according to an exemplary embodiment of the invention may comprise a ceiling element, in particular a decorative ceiling element, which is configured for accommodating the platform elements in respective storage positions.

The ceiling element may be movable, in particular pivotable, between an open access position providing access to the platform elements arranged in their respective storage positions, and a closed storage position, in which the platform elements, when arranged in their respective storage positions, are not accessible from the passenger space of the elevator car.

A method of installing a working platform according to an exemplary embodiment of the invention may include moving at least one ceiling element from a storage position into a working position for providing access to the platform elements before taking at least two platform elements from their respective storage positions.

The ceiling element may comprise at least one fixing element, in particular at least one hook, bolt or screw, configured for fixing the platform elements in their respective storage positions. The at least one fixing element in particular may be configured for extending through a corresponding fixing opening formed within the platform element for accommodating the fixing element.

The elevator car may comprise a ladder providing easy access to the working platform when arranged in the working position. The ladder may be attachable to at least one of the platform elements arranged in its working position.

In an alternative configuration, the ladder may be securely fixed to one of the platform elements and configured for being extended from said platform element after the platform element has been arranged in its working position.

### DRAWING DESCRIPTION

In the following, an exemplary embodiment of the invention is described in more detail with reference to the enclosed figures.

FIG. 1 schematically depicts an elevator system comprising an elevator car configured for moving along a hoistway.

FIG. 2 depicts a perspective view of an elevator car comprising a working platform according to an exemplary embodiment of the invention arranged in a working position.

FIGS. 3 and 4 depict enlarged perspective views of a platform element according to an exemplary embodiment of the invention.

FIG. 5 depicts an enlarged view of a leg of a platform element according to an exemplary embodiment of the invention.

FIG. 6 depicts a perspective view of an elevator car according to an exemplary embodiment of the invention in which the platform elements are arranged in their respective storage positions.

FIG. 7 depicts a perspective view of the elevator car depicted in FIG. 6, wherein a ceiling element of the elevator car is pivoted into the elevator car.

FIG. 8 depicts a perspective view of the elevator car depicted in FIGS. 6 and 7, wherein a first platform element is supported on the handrails of the elevator car.

FIG. 9 depicts a ceiling element as it is employed in an elevator car according to an exemplary embodiment of the invention.

FIG. 10 depicts an enlarged view of a fixing element provided at the ceiling element depicted in FIG. 9.

FIG. 11 depicts the ceiling element depicted in FIG. 9 with three platform elements attached to the ceiling element.

FIG. 12 depicts an enlarged view of a fixing element extending through a fixing openings formed in a platform element according to an exemplary embodiment of the invention.

### DETAILED DESCRIPTION

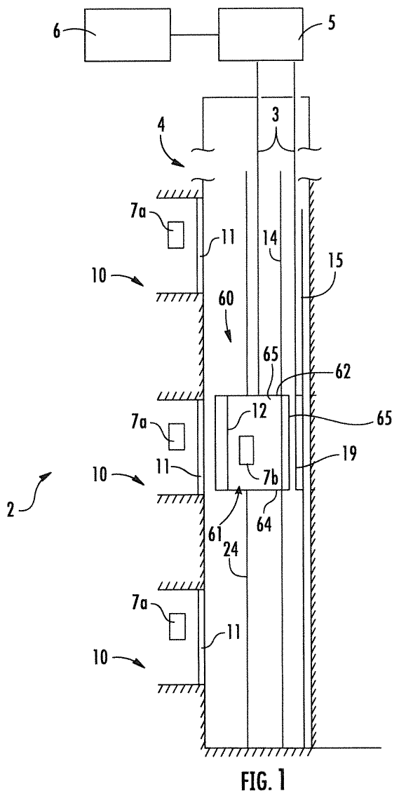

FIG. 1 schematically depicts an elevator system 2.

The elevator system 2 includes an elevator car 60 movably arranged within a hoistway 4 extending between a plurality of landings 10. The elevator car 60 in particular is movable in a longitudinal (vertical) direction along a plurality of car guide members 14, such as guide rails, extending along the vertical direction of the hoistway 4. Only one of said car guide members 14 is depicted in FIG. 1.

Although only one elevator car 60 is shown in FIG. 1, the skilled person understands that exemplary embodiments of the invention may include elevator systems 2 including a plurality of elevator cars 60 moving in one or more hoistways 4.

The elevator car 60 comprises a top 62, a bottom 64 and a plurality of sidewalls 65 extending between the top 62 and the bottom 64 of the elevator car 60 defining a passenger space 61 of the elevator car 60.

The elevator car 60 is movably suspended by means of a tension member 3. The tension member 3, for example a rope or belt, is connected to an elevator drive 5, which is configured for driving the tension member 3 in order to move the elevator car 60 along the height of the hoistway 4 between the plurality of landings 10, which are located on different floors.

The exemplary embodiment shown in FIG. 1 uses a 1:1 roping for suspending the elevator car 60. The skilled person, however, easily understands that the type of the roping is not essential for the invention and that different kinds of roping, e.g. a 2:1 roping or a 4:1 roping may be used as well.

The tension member 3 may be a rope, e.g. a steel wire rope, or a belt. The tension member 3 may be uncoated or may have a coating, e.g. in the form of a polymer jacket. In a particular embodiment, the tension member 3 may be a belt comprising a plurality of polymer coated steel cords (not shown). The elevator system 2 may have a traction drive including a traction sheave for driving the tension member 3. In an alternative configuration, which is not shown in the figures, the elevator system 2 may be an elevator system 2 without a tension member 3.

The elevator system 2 also may comprise e.g. a hydraulic drive or a linear drive. The elevator system 2 may have a machine room (not shown) or it may be a machine room-less elevator system 2.

The elevator system 2 further includes a counterweight 19 attached to the tension member 3 and configured for moving concurrently and in opposite direction with respect to the elevator car 60 along at least one counterweight guide member 15. The skilled person will understand that the invention may be applied also to elevator systems 2 which do not comprise a counterweight 19.

Each landing 10 is provided with a landing door 11, and the elevator car 60 is provided with a corresponding elevator car door 12 for allowing passengers to transfer between a landing 10 and the passenger space 61 of the elevator car 60 when the elevator car 60 is positioned at the respective landing 10.

The elevator drive 5 is controlled by an elevator controller 6 for moving the elevator car 60 along the hoistway 4 between the different landings 10.

Input to the elevator controller 6 may be provided via landing control panels 7a, which are provided on each landing 10 close to the landing doors 11, and/or via an elevator car control panel 7b, which is provided inside the elevator car 60.

The landing control panels 7a and the elevator car control panel 7b may be connected to the elevator controller 6 by means of electric wires, which are not shown in FIG. 1, in particular by an electric bus, or by means of wireless data connections.

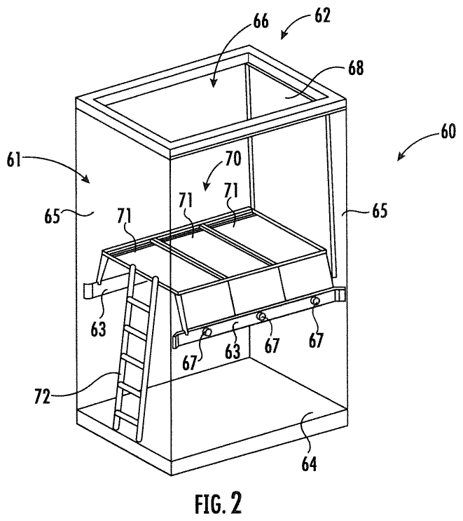

FIG. 2 depicts a perspective view of an elevator car 60 according to an exemplary embodiment of the invention.

The sidewalls 65 of the elevator car 60 are shown transparently in order to allow an unobstructed view into the elevator car 60 and the passenger space 61.

A ceiling element 68, in particular a decorative ceiling element 68, provided at the top 62 of the elevator car 60 is pivoted into the passenger space 61 of the elevator car 60 creating an opening 66 at the top 62 of the elevator 60 which allows a person, in particular a mechanic (not shown), to reach out of the top 62 of the elevator car 60.

Handrails 63 are mounted to two opposite sidewalls 65 of the elevator car 60 using connectors 67 extending between the respective handrail 63 and the corresponding sidewall 65 of the elevator car 60.

A working platform 70 according to an exemplary embodiment of the invention is arranged in a working position within the elevator car 60. The working platform 70 in particular is supported by the handrails 63.

The working platform 70 comprises a plurality of platform elements 71, in the exemplary embodiment depicted in the figures in particular three platform elements 71. The platform elements 71 are arranged next to each other on the handrails 63 forming a continuous working platform 70 extending basically over the whole cross-section of the elevator car 60.

A ladder 72 extends between the bottom (floor) 64 of the elevator car 60 and the working platform 70 allowing persons to conveniently climb onto the working platform 70.

The connectors 67 connecting the handrails 63 to the sidewalls 65 are configured strong enough for securely supporting the platform elements 71 and any persons on said platform elements 71.

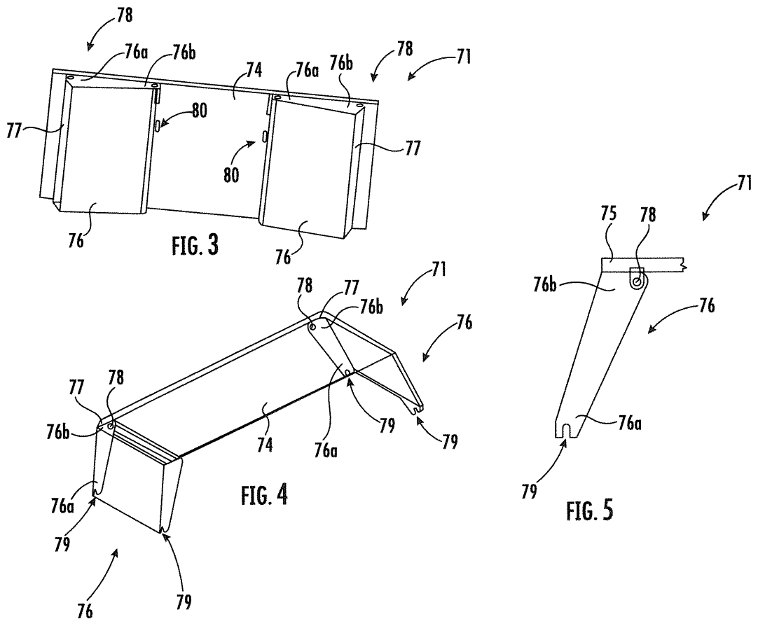

FIGS. 3 and 4 depict enlarged perspective views of a platform element 71 according to an exemplary embodiment of the invention.

The platform element 71 comprises a plate 74, in particular a rectangular plate 74, which is configured to extend horizontally within the passenger space 61 of the elevator car 60 when the platform element 71 is arranged in the working position (see FIG. 2).

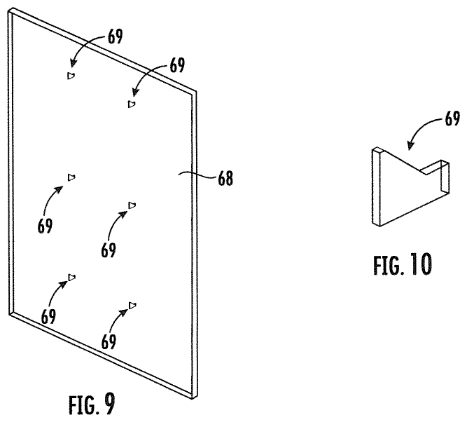

Fixing openings 80 configured for receiving the fixing elements 69, which will be described further below with respect to FIGS. 9 and 10, are formed within the plates 74 of the platform elements 71.

Two legs 76 are mounted to opposite ends of the plate 74. Each of the legs 76 is pivotably mounted to the plate 74 by means of a corresponding joint 78.

In the configuration depicted in FIG. 3, the legs 76 are arranged in respective storage positions extending basically parallel to the plate 74. In such a configuration (“storage configuration”), the space occupied by the platform element 71 is reduced, which allows storing the platform element 71 easily.

In the configuration depicted in FIG. 4, the legs 76 are arranged in respective working positions extending transversely, in particular nearly orthogonally, from the plate 74. In such a configuration (“working configuration”), the legs 76 allow supporting the platform element 71 in a working position on the handrail 63, as it is depicted in FIG. 2.

An enlarged view of a leg 76 is depicted in FIG. 5. At a first end 76a of the leg 76 opposite to the joint 78, a cutout 79 is formed within the leg 76. The cutout 79 has a shape which allows accommodating one of the handrails 63 within the cutout 79 for securely supporting the platform element on the handrails 63 (cf. FIG. 2).

A supporting surface 77 is formed at an opposing second end 76b of the leg 76 next to the joint 78. When the leg 76 is arranged in its working position, as depicted in FIGS. 4 and 5, the supporting surface 77 abuts against the plate 74 supporting the plate 74 on the leg 76. The mechanical interaction between the supporting surface 77 and the plate 74 further prevents the leg 76 from pivoting beyond the working position.

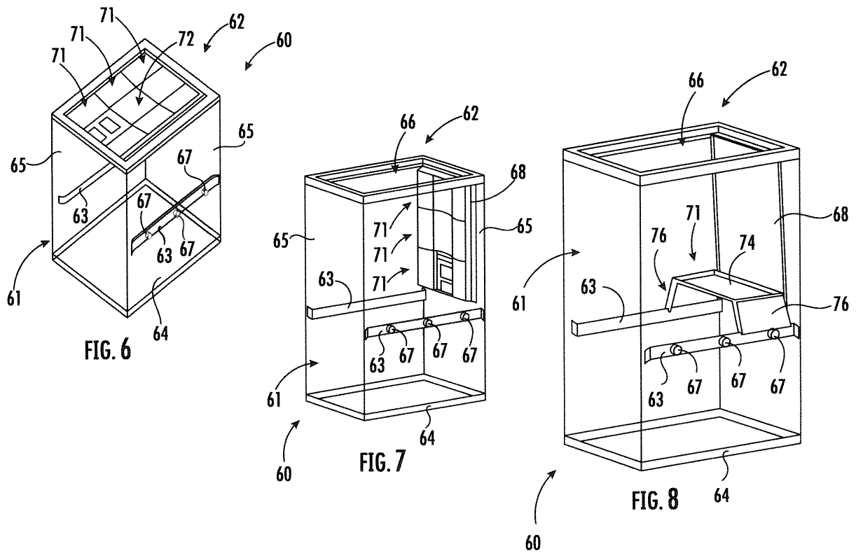

FIGS. 6 to 8 are perspective views of an elevator car 60 according to an exemplary embodiment of the invention illustrating the transfer of the working platform 70 from a storage position, which is shown in FIG. 6, into the working position depicted in FIG. 2.

In the storage position (see FIG. 6), the platform elements 71 and the ladder 72 are attached to the ceiling element 68, which is not visible in FIG. 6 as it is covered by the platform elements 71. The ceiling element 68 is arranged in a storage position, in which it extends horizontally along the top 62 of the elevator car 60. The legs 76 of the platform elements 71 are arranged in their respective storage positions extending basically parallel to the plates 74 of the platform elements 71 (cf. FIG. 3).

For installing the working platform 70 in the working position, the ceiling element 68 is unlocked and pivoted together with the platform elements 71 and the ladder 72 attached to the ceiling element 68 into the passenger space 61 of the elevator car 60. This results in a configuration as it is depicted in FIG. 7.

After the ceiling element 68 has been moved into the position depicted in FIG. 7, the platform elements 71 are successively detached from the ceiling element 68 and supported on the handrails 63 of the elevator car 60. A first platform element 71 supported on the handrails 63 is depicted in FIG. 8.

After all platform elements 71 have been detached from the ceiling element 68 and arranged on the handrails 63, the ladder 72 is attached to the last (outermost) platform element 71 so as to extend between said platform element 71 and the bottom 64 of the elevator car 60. Alternatively, the ladder 72 may be securely fixed to one of the platform elements 71 even when said platform element 71 is arranged in the storage position (see FIG. 6), in order to be extended from said platform element 71 after the platform element 71 has been arranged in its working position, in which it is supported on the handrails 63 of the elevator car 60.

FIG. 9 depicts an enlarged view of a ceiling element 68 according to an exemplary embodiment of the invention without any platform elements 71 being attached to the ceiling element 68.

The ceiling element 68 is provided with a plurality of fixing elements 69 configured for supporting the platform elements 71 when arranged in their respective storage positions. The fixing elements 69 may be securely attached to the ceiling element 68, or they may be formed integrally with the ceiling element 68.

An enlarged view of a fixing element 69 is depicted in FIG. 10. In the configuration depicted in FIGS. 9 and 10, the fixing elements 69 are provided in the form of hooks. The shape of the fixing elements 69 depicted in FIGS. 10 and 11, however, is only exemplarily. Alternative configurations of fixing elements 69, such as bolts or screws, which allow supporting the platform elements 71 at the ceiling elements 68, may be employed as well.

FIG. 11 depicts the ceiling element 68 with three platform elements 71 attached to the ceiling element 68 by fixing elements 69 extending through the fixing openings 80 formed within the plates 74 of the platform elements 71.

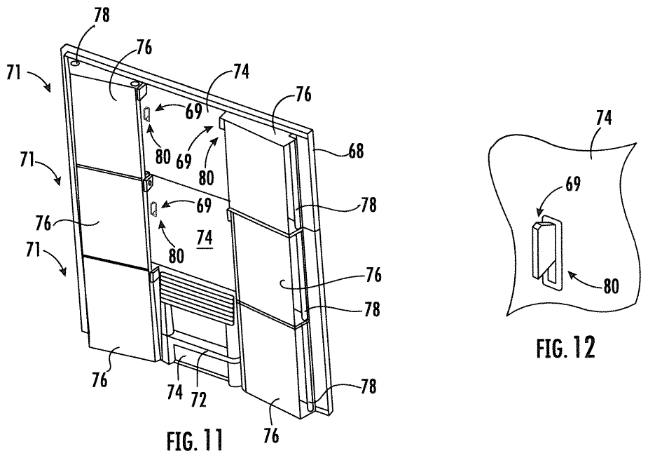

An enlarged view of a fixing element 69 extending through one of the fixing openings 80 is depicted in FIG. 12.

The fixing elements securely support the platform elements 71 when arranged in their respective storage positions at the ceiling element 68 (see FIGS. 6 and 11). The fixing elements allow detaching the platform elements 71 easily from the ceiling element 68 for transferring the platform elements 71 from their respective storage positions into the working positions forming the working platform 70 with the passenger space 61 of the elevator car 60 (see FIG. 2).

As a result, exemplary embodiments of the invention provide a working platform 70 within an elevator car 60 which allows a mechanic to position himself safely in an elevated position above the bottom (floor) 64 of the elevator car 60 and which may be installed and deinstalled easily.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling within the scope of the dependent claims.

### REFERENCES

2 elevator system

3 tension member

4 hoistway

5 elevator drive

6 elevator controller

7a landing control panel

7b elevator car control panel

10 landing

11 landing door

12 elevator car door

14 car guide member

15 counterweight guide member

19 counterweight

60 elevator car

61 passenger space

62 top of the elevator car

63 handrail

64 bottom of the elevator car

65 sidewall

66 opening

67 connector

68 ceiling element

69 fixing element

70 working platform

71 platform element

72 ladder

74 plate

76 leg

76a first end of the leg

76b second end of the leg

77 supporting surface

78 joint

79 cutout

80 fixing opening

What is claimed is:

1. Working platform for an elevator car comprising a passenger space for accommodating passengers and at least one handrail within the passenger space, the working platform comprising:
a plurality of platform elements configured for being supported in a working position within the elevator car by the at least one handrail of the elevator car for providing the working platform.

2. Working platform according to claim 1, wherein the platform elements are configured to be arranged next to each other in their respective working positions.

3. Working platform according to claim 1, wherein the platform elements, when arranged in their respective working positions, in combination provide a working platform which extends basically over the whole horizontal cross section of the passenger space.

4. Working platform according to claim 1, wherein each platform element comprises at least one leg, which is movable, in particular pivotable, between a retracted storage position and an extended working position, and configured for supporting the platform element on the at least one handrail when arranged in the extended working position.

5. Working platform according to claim 4, wherein the at least one leg comprises at least one cut-out formed within a first end of the leg and configured for accommodating a portion of the at least one handrail when the working platform is supported on said at least one handrail and/or wherein the at least one leg comprises a supporting surface at a second end of the leg, the supporting surface being configured for abutting against a plate of the platform element when the leg is arranged in its working position.

6. Working platform according to claim 4, wherein each platform element comprises two legs provided at opposite ends of the platform element.

7. Working platform according to claim 1, wherein each platform element comprises at least one fixing opening configured for accommodating a corresponding fixing element for fixing the platform element in a storage position.

8. Elevator car comprising:
at least one handrail; and
a working platform according to claim 1.

9. Elevator car according to claim 8 further comprising a ceiling element, in particular a decorative ceiling element, configured for accommodating the platform elements in respective storage positions.

10. Elevator car according to claim 9, wherein the ceiling element is movable, in particular pivotable, between an open position providing access to the platform elements arranged in their respective storage positions, and a closed position, in which the platform elements, when arranged in their respective storage positions, are not accessible from the passenger space of the elevator car.

11. Elevator car according to claim 8, wherein the ceiling element comprises a fixing element, in particular a hook, a bolt or a screw, configured for fixing the platform elements in their respective storage positions.

12. Elevator car according to claim 8 further comprising a ladder configured for providing access to the working platform when arranged in the working position.

13. Elevator system comprising
a hoistway extending between a plurality of landings; and
at least one elevator car according to claim 8 configured for moving along the hoistway between the plurality of landings.

14. Method of installing a working platform in an elevator car according to claim 8, wherein the method comprises:
taking at least two platform elements from respective storage positions; and
supporting the at least two platform elements on the at least one handrail of the elevator car.

15. Method according to claim 14, wherein the method further includes
moving at least one leg of at least one of the platform elements from a retracted storage position into an extended working position and supporting the at least one leg on the at least one handrail of the elevator car; and/or
moving at least one ceiling element from a storage position into a working position for providing access to the platform elements before taking at least two platform elements from their respective storage positions.
